(19) United States
(12) Patent Application Publication
(10) Pub. No.: US 2025/0007111 A1
(43) Pub. Date: Jan. 2, 2025

(54) CORRUGATED FOIL TABS FOR BATTERY CELLS

(71) Applicant: GM GLOBAL TECHNOLOGY OPERATIONS LLC, DETROIT, MI (US)

(72) Inventors: Feng Feng, Troy, MI (US); Sam T. Liu, Northville, MI (US); Teresa Jean Rinker, Royal Oak, MI (US); Wayne Cai, Troy, MI (US); Mansu Park, Rochester Hills, MI (US)

(21) Appl. No.: 18/342,201

(22) Filed: Jun. 27, 2023

(51) Int. Cl. H01M 50/533; B60L 50/64; H01M 50/534

(52) U.S. Cl. CPC H01M 50/533; B60L 50/64; H01M 50/534; H01M 50/103; H01M 50/107

(57) ABSTRACT

Some embodiments disclosed herein are directed to battery cells with corrugated foil tabs. Some embodiments may include a battery cell comprising a cathode, an anode and a corrugated foil tab coupled to the cathode or the anode, wherein the corrugated foil tab has a length in a first plane, includes alternating peaks and troughs in a second plane along the length of the corrugated foil tab, and has a width in a third plane, and wherein the first plane, second plane, and third plane are orthogonal to each other. Other embodiments may be disclosed or claimed.

### INTRODUCTION

The subject disclosure relates to battery cells. In particular, embodiments of the present disclosure relate to battery cells with corrugated foil tabs.

Batteries are increasingly used in a wide variety of systems, from mobile computing devices to vehicles with electric motors. Such batteries may have multiple cells, each cell including a cathode and an anode separated by a separator. Each cell typically includes a foil tab extending from the cathode and another foil tab extending from the anode, with multiple foil tabs from the cathode and anode of multiple electrodes connected to a common lead tab.

Among other things, embodiments of the present disclosure provide enhanced tabs coupled to battery cells to help to absorb shock and vibration and prevent undesirable failure modes, such as cell resistance increase, additional heat generation, and the production of undesirable byproducts which can lead to battery thermal runaway.

### SUMMARY

In one exemplary embodiment, a battery is provided. The battery comprises a cathode, an anode; and a corrugated foil tab coupled to the cathode or the anode. The corrugated foil tab has a length in a first plane, includes alternating peaks and troughs in a second plane along the length of the corrugated foil tab, and has a width in a third plane. The first plane, second plane, and third plane are orthogonal to each other.

In addition to one or more of the features described herein, the corrugated foil tab is a first corrugated foil tab coupled to the cathode, the battery cell further comprising a second corrugated foil tab coupled to the anode.

In addition to one or more of the features described herein, the first corrugated foil tab is coupled to the cathode at a first end of the first corrugated foil tab and to a first lead tab at a second end of the first corrugated foil tab, the first end of the first corrugated foil tab opposite to the second end of the first corrugated foil tab.

In addition to one or more of the features described herein, the first corrugated foil tab comprises an insulating coating on the first end of the first corrugated foil tab.

In addition to one or more of the features described herein, the insulating coating comprises a polymer and a ceramic material.

In addition to one or more of the features described herein, the insulating coating has a thickness of about 5 micrometers to 40 micrometers.

In addition to one or more of the features described herein, the first corrugated foil tab comprises a polymer coating on the second end of the first corrugated foil tab, the polymer coating including one or more of: a thermoplastic, polytetrafluoroethylene (PTFE), polyvinyl chloride (PVC), polyurethane, acrylonitrile-butadiene rubber (NBR), a polytetrafluoroethylene/butyl rubber blend, a nylon-6/polypropylene blend, and a urethane/acrylate interpenetrating polymer network.

In addition to one or more of the features described herein, the polymer coating on the second end of the first corrugated foil tab has a thickness of about one micrometer and two micrometers.

In addition to one or more of the features described herein, the second corrugated foil tab is coupled to the anode at a first end of the second corrugated foil tab and to a second lead tab at a second end of the second corrugated foil tab, the first end of the second corrugated foil tab opposite to the second end of the second corrugated foil tab.

In addition to one or more of the features described herein, the corrugated foil tab comprises copper and at least one of: about one to two percent by mass of tin, about 0.1 to 0.2 percent by mass of zinc, and about 0.2 to 0.5 percent by mass of magnesium.

In addition to one or more of the features described herein, the corrugated foil tab comprises aluminum and at least one of: about 0.1 to 0.4 percent by mass of iron, and about 0.1 to 0.5 percent by mass of silicon.

In addition to one or more of the features described herein, the battery cell has a pouch cell design, a prismatic cell design, or a cylindrical cell design.

In addition to one or more of the features described herein, the battery cell has a prismatic cell design, and wherein the corrugated foil tab is coupled directly to the cathode or the anode without any intervening connecting structure.

In addition to one or more of the features described herein, the battery cell has a prismatic cell design, and wherein the corrugated foil tab is coupled to the cathode or the anode via a non-corrugated tab extending from the cathode or the anode.

In addition to one or more of the features described herein, the battery has a cylindrical cell design, and wherein the corrugated foil tab is coupled directly to the cathode or the anode without any intervening connecting structure.

In addition to one or more of the features described herein, the battery cell has a cylindrical cell design, wherein the corrugated foil tab is coupled to the cathode or the anode at a first end of the corrugated foil tab, wherein the corrugated foil tab is coupled to a cap of the cylindrical cell at a second end of the corrugated foil tab, and wherein the first end of the corrugated foil tab is opposite to the second end of the corrugated foil tab.

In addition to one or more of the features described herein, the peaks and troughs of the corrugated foil tab have an angular cross-section in the second plane, a trapezoidal cross-section in the second plane, or combination of angular and trapezoidal cross-sections in the second plane.

In addition to one or more of the features described herein, the peaks and troughs of the corrugated foil tab have a symmetrical cross-section in the second plane or an asymmetrical cross-section in the second plane.

In another exemplary embodiment, a system is provided. The system comprises a battery cell that includes a cathode, an anode, and a corrugated foil tab coupled to the cathode or the anode. The corrugated foil tab has a length in a first plane, includes alternating peaks and troughs in a second plane along the length of the corrugated foil tab, and has a width in a third plane. The first plane, second plane, and third plane are orthogonal to each other.

In another exemplary embodiment, a vehicle is provided. The vehicle comprises an electric motor and a battery pack coupled to the electric motor, the battery pack including a battery cell. The battery cell comprises a cathode, an anode, and a corrugated foil tab coupled to the cathode or the anode. The corrugated foil tab has a length in a first plane, includes alternating peaks and troughs in a second plane along the length of the corrugated foil tab, and has a width in a third plane. The first plane, second plane, and third plane are orthogonal to each other.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a diagram of a vehicle for use in conjunction with one or more embodiments of the present disclosure;

FIG. 2A is a diagram illustrating a side view of an exemplary electrode stack design within a battery cell in accordance with embodiments of the present disclosure;

FIG. 2B is a diagram illustrating an isometric view of the exemplary electrode stack design in FIG. 2A in accordance with embodiments of the present disclosure;

FIG. 2C is a diagram illustrating an example of connecting foil tabs to a battery cell in accordance with embodiments of the present disclosure;

FIG. 2D is a diagram illustrating another example of connecting foil tabs to a battery in accordance with embodiments of the present disclosure;

FIG. 3A is a diagram illustrating the connection of foil tabs to a lead tab in accordance with embodiments of the present disclosure;

FIG. 3B is a diagram illustrating another view of the connection of foil tabs to a lead tab in FIG. 3A in accordance with embodiments of the present disclosure;

FIG. 4 illustrates diagrams of exemplary configurations of prismatic battery cell designs in accordance with various embodiments;

FIG. 5A is a diagram of a configuration of a cylindrical battery cell design in accordance with various embodiments;

FIG. 5B is a diagram of another configuration of a cylindrical battery cell design in accordance with various embodiments;

FIG. 6 is a side view of alternate corrugated foil tab configurations in accordance with one or more embodiments of the present disclosure; and

FIG. 7 illustrates an example of the dimensions and geometry of a corrugated foil tab in accordance with various embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, a battery cell with enhanced foil tabs is provided. In some embodiments, corrugated foil tabs may be attached to the cathode, anode, or both cathode and anode of an electrode stack or jelly roll for a battery cell to help provide improved flexibility and strain relief in the tab to avoid tearing the tabs from shocks or impacts during manufacturing or operation. In some embodiments, the corrugated foil tabs may include a polymer coating to further help provide damping to further reduce shocks and vibration. In this manner, embodiments of the present disclosure provide more robust and durable battery cells that are less susceptible to failures occurring from torn or damaged tabs, including cell resistance increase, additional heat generation, and generation of byproducts from the electrolyte of the cell. In some embodiments, corrugated lead tabs may be connected to the corrugated foil tabs of the cathode, anode, or both cathode and anode of a battery cell electrode stack to further provide flexibility and strain relief in the tab. This helps prevent the tabs from tearing as a result of shocks or impacts during manufacturing or operation.

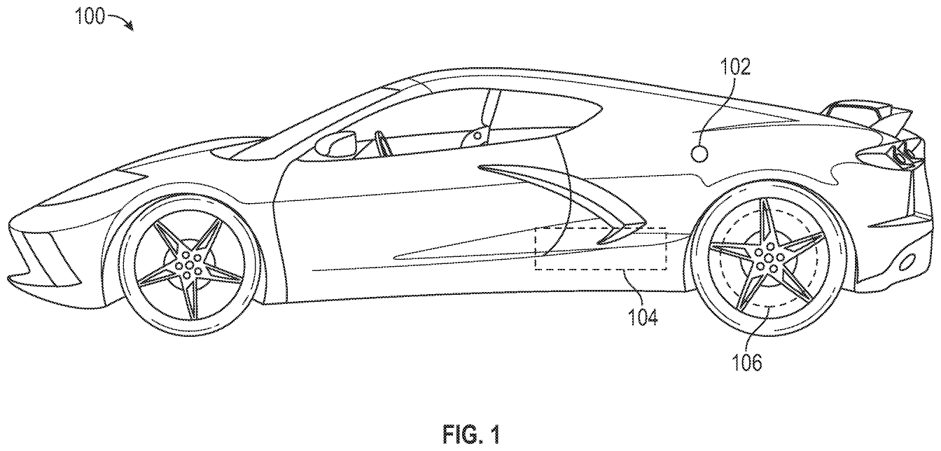

FIG. 1 provides a diagram of a vehicle 100 for use in conjunction with one or more embodiments of the present disclosure. The vehicle 100 includes a charging port 102, a battery 104, and an electric motor 106. In one embodiment, the vehicle 100 is a hybrid vehicle that utilizes both an internal combustion engine and an electric motor. In another embodiment, the vehicle 100 is an electric vehicle that only utilizes electric motors. In exemplary embodiments, the vehicle 100 is configured to be connected, via charging port 102, to a high-voltage power source (i.e., a voltage source of at least 200 volts (V)), which is used to charge the battery 104. The electric motor 106 is configured to receive power from the battery 104 to provide propulsion for the vehicle 100.

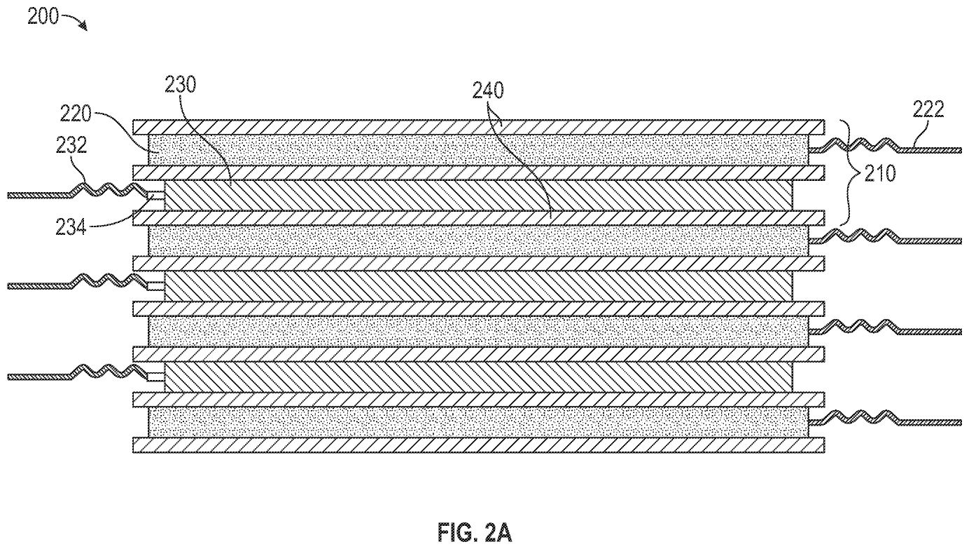

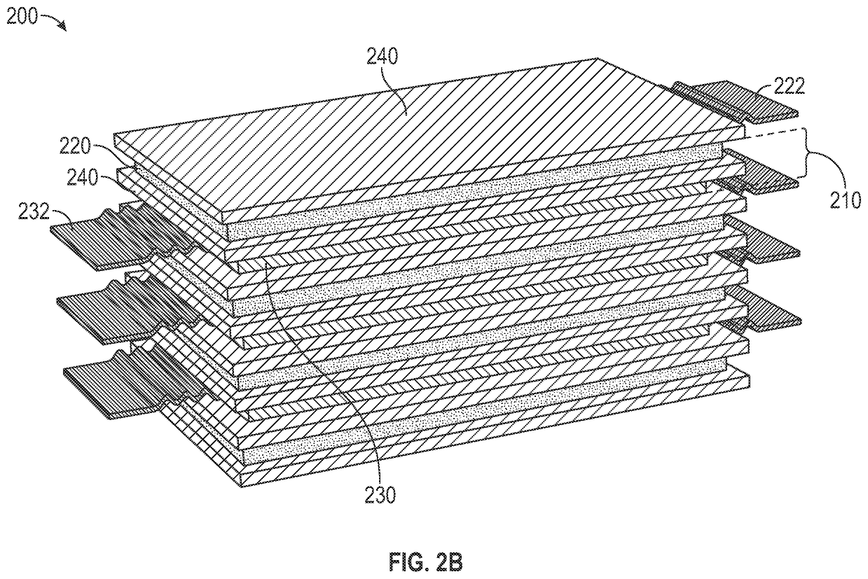

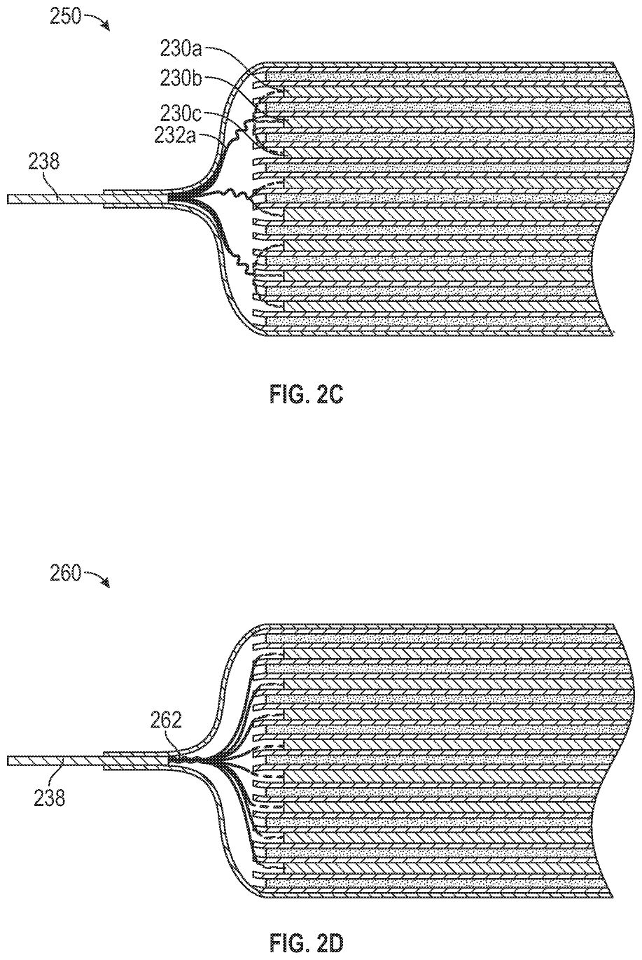

FIG. 2A is a diagram illustrating a side view of an exemplary battery cell design in accordance with embodiments of the present disclosure. In this example, a battery cell 200 includes a plurality of bi-cells, each bi-cell comprising an anode/cathode pair. For example, a bi-cell 210 comprises an anode 220 and a cathode 230. Each anode and cathode have active material coatings on the foil films that are employed as the current collectors. The foil tabs have no active material coating and are located at one side of each anode and cathode. The foil tabs are obtained through a notching process. Each anode and cathode in the battery cell 200 has a corresponding corrugated portion that may be part of a unitary extension of an existing foil tab, or (alternatively) the cell's existing foil tab may be coupled to a separate and extended corrugated foil tab. For example, in bi-cell 210, anode 220 has a unitary extension of corrugated foil tab 222 and cathode 230 has a unitary extension of corrugated foil tab 232. Anode 220 and cathode 230 are further separated by insulating layers 240. FIG. 2B illustrates an isometric view of battery cell 200 and bi-cell 210.

As illustrated in FIG. 2A, corrugated foil tab 232 coupled to cathode 230 includes an insulated-coated portion 234 proximate to the edge of the cathode 230 to help avoid contact (and thus shorting) between the anode 220 and cathode 230. In this example, the cathode 230 is smaller than the anode 220 in all dimensions. In this example, there is no such corresponding insulation coating on the corrugated foil tab 222 coupled to the anode edge. In some embodiments, the insulated portion 234 may be part of a unitary structure of tab 232, with no intervening connecting structures. Alternatively, insulated portion 234 may be a separate structure that is coupled to tab 232 (e.g., via welding or riveting).

As shown in FIGS. 2A and 2B, the corrugated foil tabs 222, 232 may have a length in a first plane (e.g., x-plane) with alternating peaks and troughs in a second plane (e.g., y-plane) and width in third plane (e.g., z-plane), with the first, second and third planes orthogonal to each other in a three-dimensional configuration. The corrugated foil tabs 222, 232 may have any suitable dimensions to provide sufficient mechanical strength and conduct current from the battery bi-cell 210. In some embodiments, for example, the corrugated foil tabs 222, 232 have a thickness in the range of about 5 μm˜200 μm.

The insulation coating on portion 234 may comprise a polymer (e.g., Polyvinylidene fluoride or PVDF) binder and a ceramic (e.g., aluminum oxide powder 10˜50 wt %, and/or rare earth oxide 0.1˜3 wt %). In some embodiments, the insulative coating at portion 234 may have a width of about between 2.0-6.0 mm and a thickness of about between 5-40 μm.

In some embodiments, corrugated foil tabs 222 may comprise copper (e.g., with 99.9 wt % copper and 0.1 wt % phosphorus). In some embodiments, corrugated foil tabs 232 may comprise aluminum (e.g., 99.0-99.95 wt % aluminum and 0.05-0.20 wt % copper). In some embodiments, the corrugated foil tabs 222 and 232 may comprise copper alloys or aluminum alloys. For example, copper alloys may include copper and one or more of the following components by mass percent: 1.0-2.0 of Sn, 0.1-0.2 of Zn, 0.2-0.5 of Mg. In another example, aluminum alloys may include aluminum and one or more of the following components by mass percent: 0.1-0.4 of Fe, 0.1-0.5 of Si. In some embodiments, corrugated foil tabs of the present disclosure may include C110 (99.9% Cu). In some embodiments, corrugated foil tabs of the present disclosure may include Al 1100 (99-99.95% Al, Cu 0.2-0.6%, Fe≤0.4%, Mn≤0.15%, Si≤0.4%, Ti≤0.15%.).

Corrugated foil tabs may be coupled to the cathodes and anodes of a battery cell in conjunction with embodiments of the present disclosure in a variety of configurations. Corrugated foils may be consolidated into one or multiple groups. For example, FIG. 2C is a diagram illustrating an example of connecting foil tabs to a battery cell in accordance with embodiments of the present disclosure. In this example, battery cell 250 illustrates a plurality of cathodes coupled to individual corrugated foil tabs. The battery cell 250 has corresponding corrugated portion that may be part of a unitary extension of an existing foil tab, or the cell's existing foil tab may be coupled to a separate and extended corrugated foil tab. For example, corrugated foil tab 232a is a unitary extension of foil tabs of cathode 230a, cathode 230b, and cathode 230c at a first end, and to lead tab 238 at a second end (the first and second ends opposite to each other). The existing foil tabs of cathode 230a, cathode 230b, and cathode 230c may be corrugated together at one time. One advantage of the configuration illustrated in FIG. 2C is to simplify the implementation of the corrugated tabs by reducing the total number of foil tab layers for corrugation. Additionally, in some embodiments some foil tabs may be corrugated and others non-corrugated to, for example, provide corrugated tabs in portions of the battery cell that tend to experience higher stress than other portions of the battery.

FIG. 2D is a diagram illustrating another example of connecting foil tabs to a battery cell 260 in accordance with embodiments of the present disclosure. In this example, jointly corrugated foil tab 262 is a unitary extension of a plurality of all cathode foil tabs and is in turn coupled to lead tab 238. Among other things, this configuration may help improve the efficiency of manufacturing battery cells in accordance with embodiments of the present disclosure by minimizing the corrugation to tab 262.

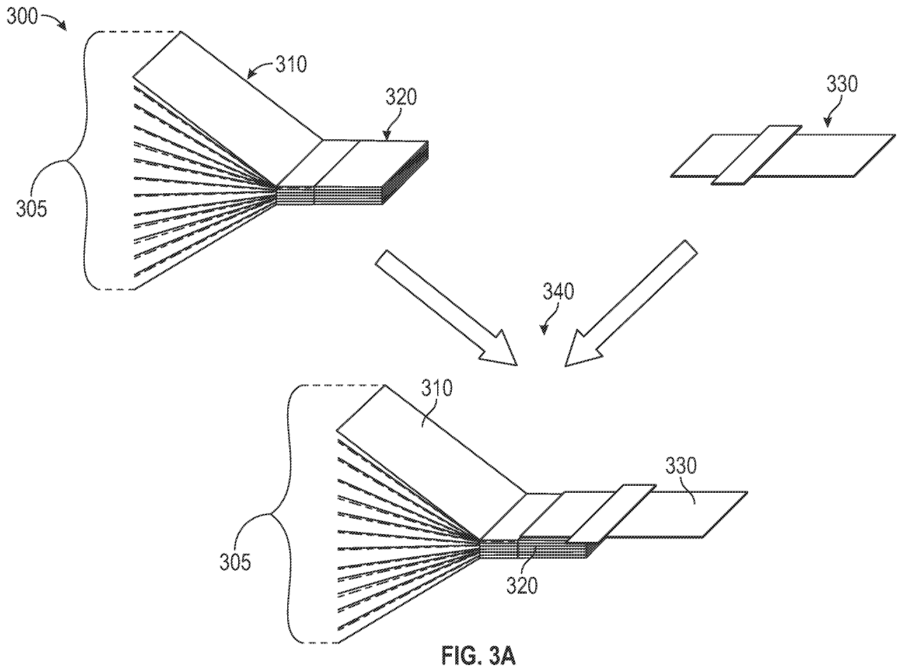

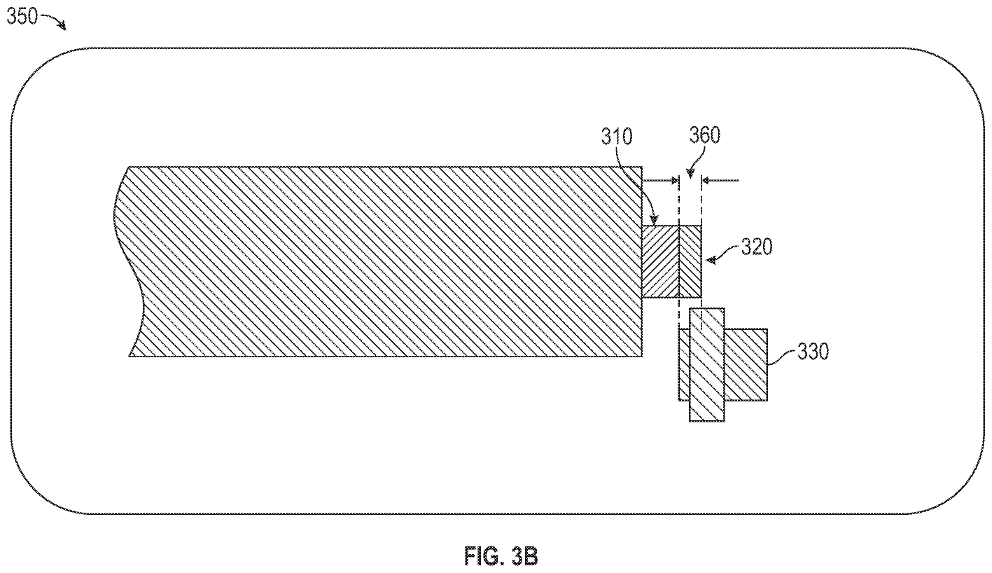

FIG. 3A is a diagram illustrating the connection of foil tabs to a lead tab in accordance with embodiments of the present disclosure. In this example, diagram 300 illustrates portions of corrugated foil tabs 305 (e.g., corrugated foil tabs 222, 232 from FIG. 2A) with a polymer-coated surface 310 and an uncoated surface 320. A lead tab 330 is also shown. The foil tabs 305 are combined, at 340, such that the uncoated surface 320 is coupled to the lead tab 330 as illustrated. In some embodiments, the lead tab coupled to a corrugated foil tab (e.g., lead tab 330) may also be corrugated and/or include a coated and non-coated portion.

FIG. 3B is a diagram 350 illustrating another view of the connection of foil tabs to a lead tab in FIG. 3A in accordance with embodiments of the present disclosure. In this example, the positioning of lead tab 330 relative to welding zone 360 is illustrated.

In the examples depicted in FIG. 3A and FIG. 3B, the coating on portion 310 can act as a damper to help eliminate or reduce vibrational energy through friction. In some embodiments, the coating material may include polymers (such as thermoplastics) or polymer composites. Example of polymers that may be utilized on the coated surface 310 include polytetrafluoroethylene (PTFE), polyvinyl chloride (PVC), polyurethane, acrylonitrile-butadiene rubber (NBR), a polytetrafluoroethylene/butyl rubber blend, a nylon-6/polypropylene blend, and a urethane/acrylate interpenetrating polymer network.

In some embodiments, the coated surface 310 may include an elastomer or other amorphous thermoplastics with a glass transition temperature below room temperature. In some embodiments, the coated surface may include a polymer blend or interpenetrating network. For example, in one embodiment the coating material may include a polymer composition with 50:50 or 30:70 of polyvinyl chloride (PVC) and acrylonitrile-butadiene rubber (NBR). In some embodiments, the coating material on coated surface 310 may have a thickness in the range of about 1-2 μm. As illustrated in FIG. 3A and FIG. 3B, the coated surface 310 may begin from the edge of the electrode and end at the edge of the tab welding zone 360. Among other things, this helps ensure the coating will not interfere with welding the foil tabs 305 to the lead tab 330.

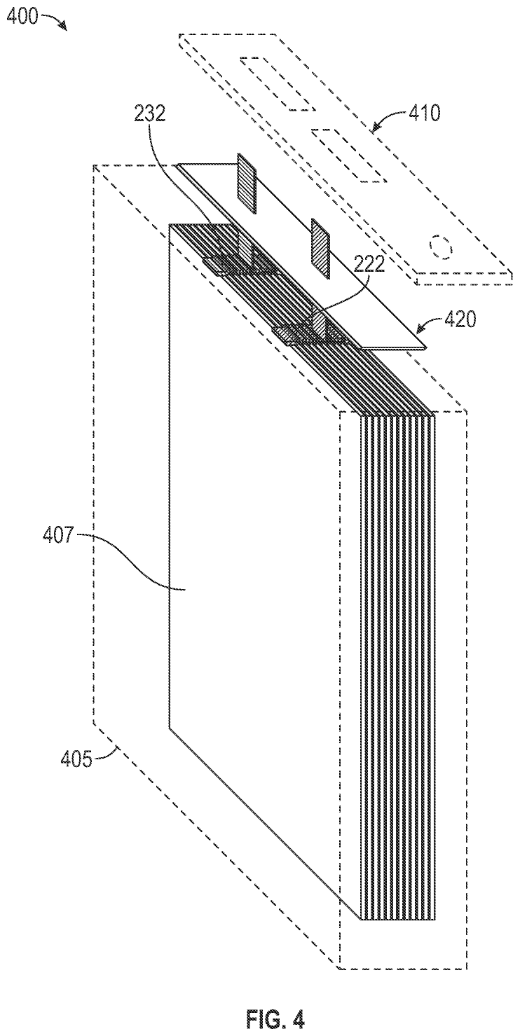

The corrugated foil tabs described herein may be used in conjunction with a variety of different battery cell designs. For example, FIG. 4 is a diagram of a configuration of a prismatic battery cell design in accordance with various embodiments. In this example, battery cell 400 comprises corrugated foil tabs 222, 232 which may be unitary structures extending from the anodes and cathodes or coupled to the anodes and cathodes of the battery cell 400, respectively. Battery cell 400 in this example is a “jelly-roll” structure 407 encased in a can 405. In this example, the jelly-roll 407 is a flat-winded jelly-roll structure, but embodiments of the present disclosure may operate in conjunction with a stacked jelly roll structure or any other suitable battery design configuration. Insulation layer 420 separates corrugated foil tabs 222, 232 to prevent them from shorting, and the corrugated foil tabs 222, 232 are coupled to the cell header 410.

As introduced above, the corrugated foil tabs 222, 232 may be unitary structures extending from the existing foil tabs from anodes and cathodes or may be coupled (e.g., via welding) to a tab (itself corrugated or non-corrugated) extending from the anodes and cathodes. In this example, the corrugated foil tabs 222, 232 are coupled to the extended foil tabs that directly connect to the cell holder 410, but in alternate embodiments the corrugated foil tabs 222, 232 may be coupled to the anodes and cathodes on opposing or orthogonal sides of the battery cell 400.

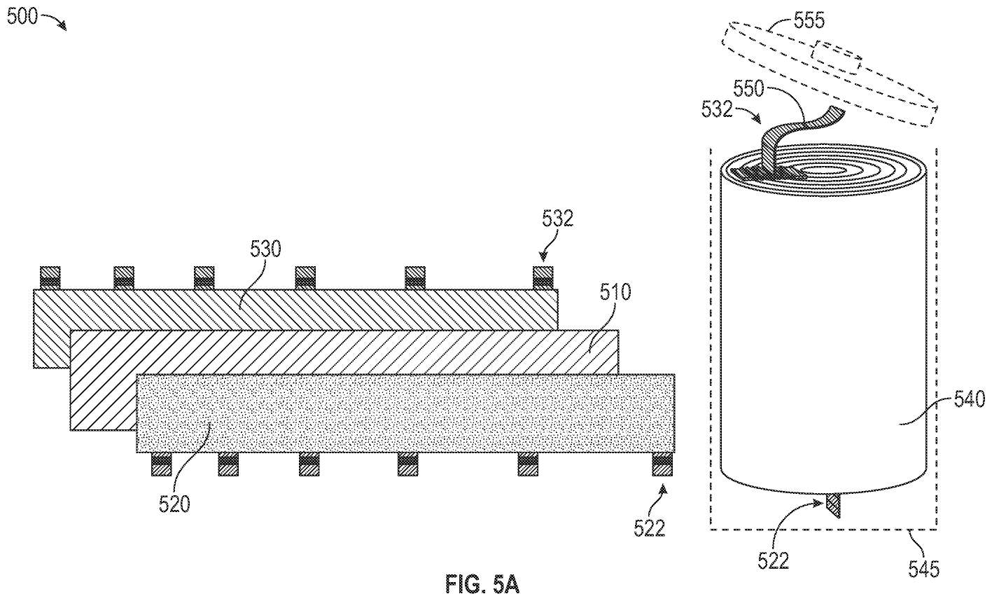

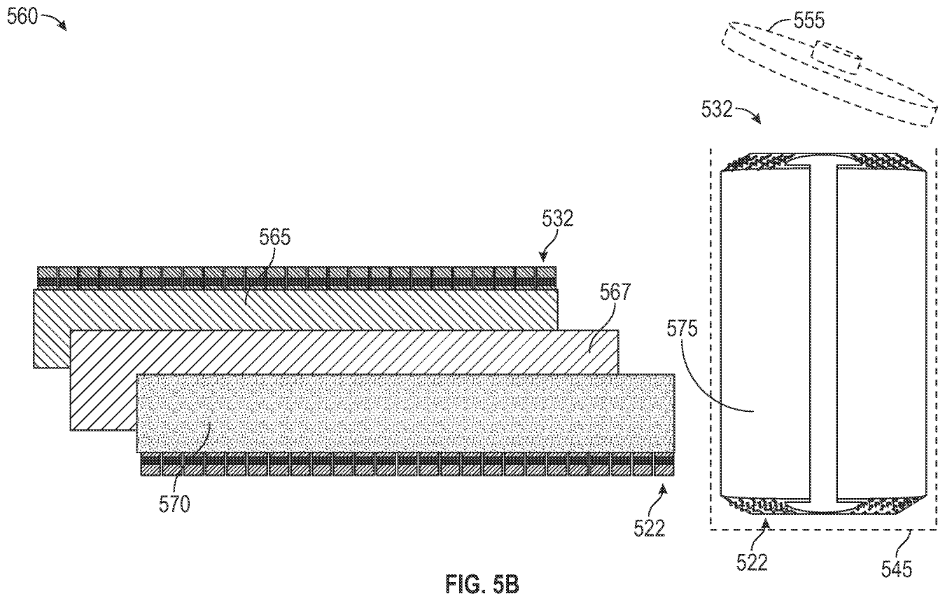

In another example, FIG. 5A is a diagram of a configuration of a cylindrical battery cell design in accordance with various embodiments. Here, battery cell 500 comprises a cathode layer 530 with corrugated foil cathode tabs (e.g., tab 532) extending therefrom. Battery cell 500 further includes an anode layer 520 with corrugated foil anode tabs extending therefrom (e.g., tab 522). Cathode layer 530 and anode layer 520 are rolled together in a jell-roll structure 540 with separator layer 510 in between. The jelly-roll structure 540 is enclosed within a can 545. Internal lead 550 is coupled at one end to the cathode tabs and at its other end to cap 555.

In some embodiments, the internal lead 550 may be a unitary extension of the corrugated foil tabs (without any intervening connecting structures), or a separate part connected to the corrugated foil tabs. In some embodiments, the internal lead 550 is a separate non-corrugated structure coupled to the corrugated foil tabs.

FIG. 5B is a diagram of another configuration of a cylindrical battery cell design in accordance with various embodiments. In this example, battery cell 560 comprises a cathode layer 565 and anode layer 570 rolled together in a jelly-roll structure 575 with separator layer 567 in between. In this example, the cylindrical battery cell 560 comprises a relatively larger number of corrugated foil tabs than the design illustrated in FIG. 5A, with much less of a gap between each tab than the design in FIG. 5A. In this example, the corrugated foil tabs extending from the cathode layer 565 (e.g., tab 532) and anode layer 570 (e.g., tab 522) are crimped or welded to the top and bottom of the can 545.

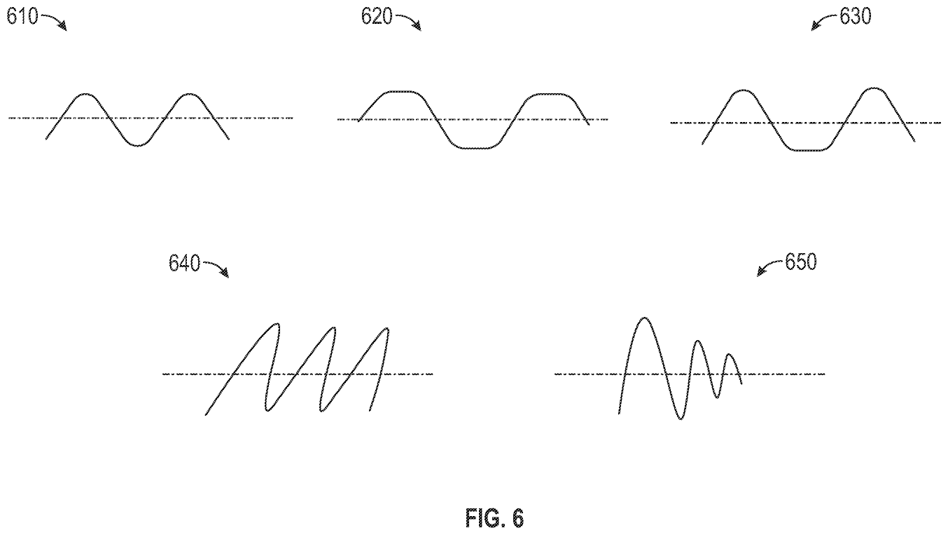

FIG. 6 illustrates side views of alternate corrugated foil tab configurations in accordance with one or more embodiments of the present disclosure. In this example, configurations 610-650 illustrate side views of exemplary corrugation configurations (e.g., in the x-y plane). For example, configuration 610 illustrates an angular corrugation pattern, where the alternating peaks and troughs are symmetrical, and the peaks and troughs have an angle that is less than ninety degrees. Configuration 620 illustrates a trapezoidal corrugation configuration where the alternating peaks and troughs have an extended flattened portion. Configuration 630 illustrates an example of a mixed angular and trapezoidal configuration where the peaks are angular and the troughs are trapezoidal.

Embodiments of the present disclosure may also utilize other corrugation configurations. For example, configuration 640 illustrates a corrugation configuration with more tightly angled peaks and troughs than configuration 610, and where the peaks and troughs lean (to the right in this example). The geometry of the corrugated foil tabs utilized in conjunction with embodiments of the present disclosure may be symmetric (as shown in configurations 610 and 620) or asymmetric, as illustrated in configuration 650, where the alternating peaks and troughs are not the same amplitude.

In some embodiments, asymmetric corrugation may be used so that various empty spaces within a cell can accommodate various corrugation structures. As an example, the end of a corrugation pattern with a diminishing size or height (as shown on the right portion of configuration 650) may be advantageously used at the edges of a welding area, while the other end of corrugation with a relatively large size or height (as shown on the left portion of configuration 650) may be used at the electrode edges where the large empty space can accommodate the corrugation structure.

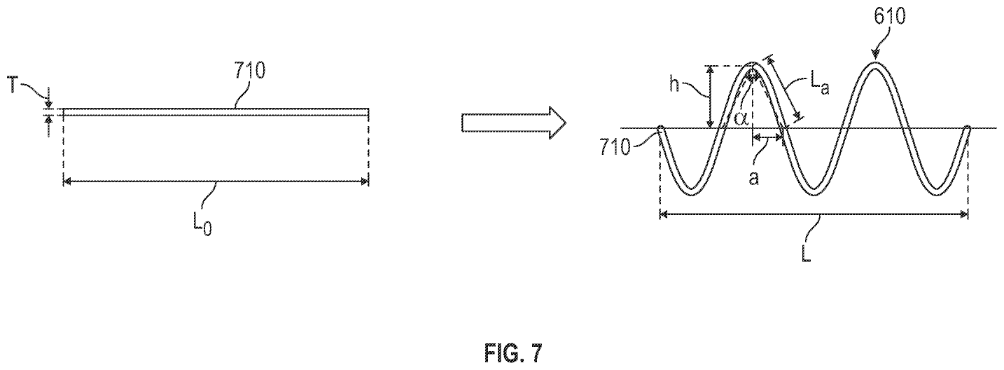

FIG. 7 illustrates an example of the dimensions and geometry of a corrugated foil tab in accordance with various embodiments. In this example, the periodic unit wave pattern in configuration 610 from FIG. 6 is illustrated. Here, the foil 710 prior to corrugation is shown with effective length L0 in a first plane (e.g., x-plane) and a thickness T in a second plane (e.g, y-plane). As introduced above, the foil 710 further has a width (not shown in FIG. 7) in a third plane (e.g., z-plane), where the first plane, second plane, and third plane are orthogonal to each other in a 3-dimensional configuration. In some embodiments, length L0 may be less than about 30 mm and may be configurated based on the available space within the cells of a particular battery. The variables associated with periodic unit wave pattern in configuration 610 are as follows:
h: height of periodic unit wave
α: angle of the periodic unit wave
a: half of the wavelength in corrugated foil tab: a=h*tan(α/2)
La: ¼ length of periodic unit wave: La=h/cos(α/2)
n: number of periodic unit wave: n=L0/(2a)
L: total length of foil tab in corrugated part: L=(2La)*n

For example, for the symmetrical angled corrugated foil tab 610 shown in FIG. 7, if the effective length is 5 mm, the height of unit wave is 250 μm, the angle of the unit wave is 60°, the number of unit waves can be calculated as 8, the actual length of the foil tab may be calculated as 10 mm. Analogizing the corrugation pattern in FIG. 7 to a sine wave, the width of the band-gap of the wave is thus controlled by the height of the periodic unit wave (h) and the angle of the periodic unit wave (a). The number, height, angle and band-gap of the periodic corrugated waves, and the total length of the corrugated foil tab, may be determined for use in manufacturing and quality control.

For a non-symmetric or an irregular corrugation of a foil tab, such as illustrated in configuration 650 in FIG. 6, the actual length of the foil tab may be estimated based on the similar symmetrical triangled corrugation, and then adjusted based on the available empty space within the cell. Another way to estimate the actual length of the foil tab may be based on the energy absorption measurement during the shock or vibration testing. For example, in some embodiments, a Cu foil tab with a corrugated structure (5 mm displacement) in accordance with embodiments of the present disclosure may improve energy absorption by over 500%. Similarly, an Al foil tab with a corrugated structure (4 mm displacement) in accordance with embodiments of the present disclosure may improve energy absorption by over 450%. Accordingly, if 10 times of energy absorption is required, 8-10 mm extra lengths of Cu or Al foil tabs may be needed. The width of band-gap may be estimated based on the effective length and the actual length of each foil tab. In some embodiments, for a corrugated lead tab, the actual length of lead tabs may similarly be estimated based on the energy absorption requirement.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery cell, comprising:
a cathode;
an anode; and
a corrugated foil tab coupled to the cathode or the anode, wherein the corrugated foil tab has a length in a first plane, includes alternating peaks and troughs in a second plane along the length of the corrugated foil tab, and has a width in a third plane, and wherein the first plane, second plane, and third plane are orthogonal to each other.

2. The battery cell of claim 1, wherein the corrugated foil tab is a first corrugated foil tab coupled to the cathode, the battery cell further comprising a second corrugated foil tab coupled to the anode.

3. The battery cell of claim 2, wherein the first corrugated foil tab is coupled to the cathode at a first end of the first corrugated foil tab and to a first lead tab at a second end of the first corrugated foil tab, the first end of the first corrugated foil tab opposite to the second end of the first corrugated foil tab.

4. The battery cell of claim 3, wherein the first corrugated foil tab comprises an insulating coating on the first end of the first corrugated foil tab.

5. The battery cell of claim 4, wherein the insulating coating comprises a polymer and a ceramic material.

6. The battery cell of claim 4, wherein the insulating coating has a thickness of about 5 micrometers to 40 micrometers.

7. The battery cell of claim 3, wherein the first corrugated foil tab comprises a polymer coating on the second end of the first corrugated foil tab, the polymer coating including one or more of: a thermoplastic, polytetrafluoroethylene (PTFE), polyvinyl chloride (PVC), polyurethane, acrylonitrile-butadiene rubber (NBR), a polytetrafluoroethylene/butyl rubber blend, a nylon-6/polypropylene blend, and a urethane/acrylate interpenetrating polymer network.

8. The battery cell of claim 7, wherein the polymer coating on the second end of the first corrugated foil tab has a thickness of about one micrometer and two micrometers.

9. The battery cell of claim 3, wherein the second corrugated foil tab is coupled to the anode at a first end of the second corrugated foil tab and to a second lead tab at a second end of the second corrugated foil tab, the first end of the second corrugated foil tab opposite to the second end of the second corrugated foil tab.

10. The battery cell of claim 1, wherein the corrugated foil tab comprises copper and at least one of: about one to two percent by mass of tin, about 0.1 to 0.2 percent by mass of zinc, and about 0.2 to 0.5 percent by mass of magnesium.

11. The battery cell of claim 1, wherein the corrugated foil tab comprises aluminum and at least one of: about 0.1 to 0.4 percent by mass of iron, and about 0.1 to 0.5 percent by mass of silicon.

12. The battery cell of claim 1, wherein the battery cell has a pouch cell design, a prismatic cell design, or a cylindrical cell design.

13. The battery cell of claim 12, wherein the battery cell has a prismatic cell design, and wherein the corrugated foil tab is coupled directly to the cathode or the anode without any intervening connecting structure.

14. The battery cell of claim 12, wherein the battery cell has a prismatic cell design, and wherein the corrugated foil tab is coupled to the cathode or the anode via a non-corrugated tab extending from the cathode or the anode.

15. The battery cell of claim 12, wherein the battery cell has a cylindrical cell design, and wherein the corrugated foil tab is coupled directly to the cathode or the anode without any intervening connecting structure.

16. The battery cell of claim 12, wherein the battery cell has a cylindrical cell design, wherein the corrugated foil tab is coupled to the cathode or the anode at a first end of the corrugated foil tab, wherein the corrugated foil tab is coupled to a cap of the cylindrical cell at a second end of the corrugated foil tab, and wherein the first end of the corrugated foil tab is opposite to the second end of the corrugated foil tab.

17. The battery cell of claim 1, wherein the peaks and troughs of the corrugated foil tab have an angular cross-section in the second plane, a trapezoidal cross-section in the second plane, or combination of angular and trapezoidal cross-sections in the second plane.

18. The battery cell of claim 1, wherein the peaks and troughs of the corrugated foil tab have a symmetrical cross-section in the second plane or an asymmetrical cross-section in the second plane.

19. A system, comprising:
a battery cell that includes:
a cathode;
an anode; and
a corrugated foil tab coupled to the cathode or the anode, wherein the corrugated foil tab has a length in a first plane, includes alternating peaks and troughs in a second plane along the length of the corrugated foil tab, and has a width in a third plane, and wherein the first plane, second plane, and third plane are orthogonal to each other.

20. A vehicle comprising:
an electric motor; and
a battery pack coupled to the electric motor, the battery pack including a battery cell, comprising:
a cathode;
an anode; and
a corrugated foil tab coupled to the cathode or the anode, wherein the corrugated foil tab has a length in a first plane, includes alternating peaks and troughs in a second plane along the length of the corrugated foil tab, and has a width in a third plane, and wherein the first plane, second plane, and third plane are orthogonal to each other.
